(19) United States
(12) Patent Application Publication
(10) Pub. No.: US 2021/0096227 A1
(43) Pub. Date: Apr. 1, 2021

(54) METHOD OF MONITORING SYSTEM STATUS OF LIDAR, AND LIDAR

(71) Applicant: SZ DJI TECHNOLOGY CO., LTD., Shenzhen (CN)

(72) Inventors: Chenghui LONG, Shenzhen (CN); Tao LI, Shenzhen (CN); Xiaoping HONG, Shenzhen (CN)

(21) Appl. No.: 17/118,523

(22) Filed: Dec. 10, 2020

Related U.S. Application Data
(63) Continuation of application No. PCT/CN2018/092567, filed on Jun. 25, 2018.

(51) Int. Cl. G01S 7/497; G01S 17/10; G01S 7/481; G01K 13/00

(52) U.S. Cl. CPC G01S 7/497; G01S 17/10; G01K 13/00; G01S 7/4816; G01S 7/4817; G01S 7/4814

(57) ABSTRACT

A method of monitoring a system status of a LIDAR includes obtaining M pieces of present status information corresponding to N devices of the LIDAR, determining system status information of the LIDAR according to the M pieces of present status information, and outputting the system status information of the LIDAR and the M pieces of present status information through a preset field. Each of the N devices corresponds to at least one of the M pieces of present status information. N is an integer greater than or equal to 2, and M is an integer greater than or equal to N.

### CROSS-REFERENCE TO RELATED APPLICATION

This application is a continuation of International Application No. PCT/CN2018/092567, filed Jun. 25, 2018, the entire content of which is incorporated herein by reference.

### TECHNICAL FIELD

The present disclosure generally relates to the LIDAR technology field and, more particularly, to a method of monitoring a system status of a LIDAR and a LIDAR.

### BACKGROUND

A method of monitoring a system status mainly includes log record monitoring and error code monitoring. The log record monitoring is usually applied to software of a personal computer (PC) with rich hardware resources. However, many resources are occupied during a monitoring process, which has a great impact on the real-time performance of the system. For the error code monitoring, an operator may quickly find a reason why the software or hardware cannot operate normally by recognizing an error code.

For a LIDAR whose system is an embedded system, system status information is usually recorded by the error code monitoring. In the existing technology, when the system status information is recorded by the error code monitoring, status information that can be represented is limited, which cannot well provide feedback about the status of the whole system. Therefore, the efficiency of obtaining the system status of the LIDAR is not high.

### SUMMARY

Embodiments of the present disclosure provide a method of monitoring a system status of a LIDAR. The method includes obtaining M pieces of present status information corresponding to N devices of the LIDAR, determining system status information of the LIDAR according to the M pieces of present status information, and outputting the system status information of the LIDAR and the M pieces of present status information through a preset field. Each of the N devices corresponds to at least one of the M pieces of present status information. N is an integer greater than or equal to 2, and M is an integer greater than or equal to N.

Embodiments of the present disclosure provide a LIDAR including a memory and a processor. The memory stores a program instruction. The processor is configured to obtain M pieces of present status information corresponding to N devices of the LIDAR, determine system status information of the LIDAR according to the M pieces of present status information, and output the system status information of the LIDAR and the M pieces of present status information through a preset field. Each one of the N devices corresponds to at least one of the M pieces of present status information. N is an integer greater than or equal to two, and M is an integer greater than or equal to N.

### BRIEF DESCRIPTION OF THE DRAWINGS

FIG. 1 is a schematic structural diagram of a LIDAR.

FIG. 2 is a schematic flowchart of a method of monitoring a system status of a LIDAR according to some embodiments of the present disclosure.

FIG. 3 is a schematic diagram showing a preset field according to some embodiments of the present disclosure.

FIG. 4 is a schematic structural diagram of a LIDAR according to some embodiments of the present disclosure.

### DETAILED DESCRIPTION OF THE EMBODIMENTS

To make purposes, technical solutions, and advantages of embodiments of the present disclosure clearer, the technical solution of embodiments of the present disclosure is described in detail in connection with the accompanying drawings. Described embodiments are some embodiments not all embodiments of the present disclosure. Based on embodiments of the present disclosure, all other embodiments obtained by those of ordinary skill in the art without creative efforts are within the scope of the present disclosure. With no conflict, embodiments and features of embodiments may be combined with each other.

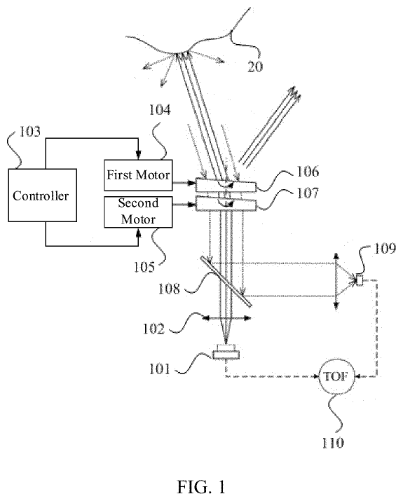

A method of monitoring a system status of a LIDAR consistent with embodiments of the present disclosure may be applied to a LIDAR. For example, FIG. 1 is a schematic structural diagram of a LIDAR. As shown in FIG. 1, the LIDAR includes a laser device 101, a lens 102, a controller 103, a first motor 104, a second motor 105, a first prism 106, a second prism 107, a beam splitter 108, a receiver 109, and a time of flight (TOF) device. The receiver 109 may include an avalanche photo diode (APD). For example, when the LIDAR is used to detect a distance to a target 20, the laser device 101 of the LIDAR may change an electrical pulse signal into a divergent light pulse signal. The lens 102 may change the divergent light pulse signal into a parallel light pulse signal. The controller 103 (e.g., arranged in a chip) may control a rotation of the first prism 106 through the first motor 104, control a rotation of the second prism 107 through the second motor 105, such that the parallel light pulse signal passing through the first prism and the second prism may be emitted out. After the emitted light pulse signal hits the target 20, the light pulse signal may be reflected. The reflected pulse signal may be split by the beam splitter 108 and enter the receiver 109 (including APD). The receiver 109 may convert the light pulse signal into an electrical pulse signal. The distance between the LIDAR and the target 20 may be calculated by the TOF device 110 (e.g., arranged in a chip). According to the above, how to monitor the system status of the LIDAR is very important during the operation of the LIDAR.

Specific embodiments are used to describe the technical solution of the present disclosure and how the technical solution of the present disclosure solves the technical solution. Specific embodiments may be combined with each other, and same or similar concepts or processes may not be repeated in some embodiments. Embodiments of the present disclosure are described in connection with the accompanying drawings.

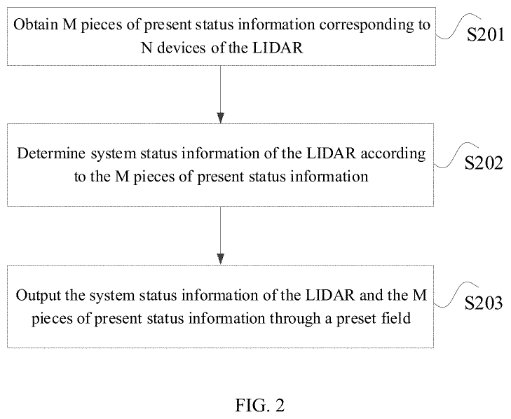

FIG. 2 is a schematic flowchart of a method of monitoring a system status of a LIDAR according to some embodiments of the present disclosure. The method of monitoring the system status of the LIDAR may be executed by the LIDAR. For example, as shown in FIG. 2, the method of monitoring the system status of the LIDAR includes the following processes.

At S201, M pieces of present status information corresponding to N devices of the LIDAR is obtained.

Each of the N devices may correspond to at least one piece of status information. N may be an integer greater than or equal to 2. M may be an integer greater than or equal to N.

The N devices may include the laser device, the APD, and the chip. When the N devices include the laser device, the APD, and the chip, the corresponding M pieces of present status information may include a present temperature of the laser device, a present temperature of the APD, and a present temperature of the chip, and/or the N devices may include the first motor and the second motor. When the N devices include the first motor and the second motor, the M pieces of present status information may include a rotation speed of the first motor and a rotation speed of the second motor. The LIDAR may further include other devices. In embodiments of the present disclosure, the LIDAR including the laser device, the APD, and the chip, and/or the first motor and the second motor is described as an example. However, embodiments of the present disclosure are not limited to this.

At S202, system status information of the LIDAR is determined according to the M pieces of present status information.

After the M pieces of present status information corresponding to the N devices are obtained at S201, the system status information of the LIDAR may be determined according to the M pieces of present status information.

At S203, the system status information of the LIDAR and the M pieces of present status information are output through a preset field.

In some embodiments, when the system status information of the LIDAR and the M pieces of present status information are output through the preset field, the M pieces of present status information may occupy different bits of the preset field. In some embodiments, the bits occupied by the M pieces of present status information in the preset field may be determined by priority levels of various devices or set randomly. In embodiments of the present disclosure, an example is described to determine the bits occupied by the M pieces of present status information in the preset field according to the priority levels of the various devices. However, embodiments of the present disclosure are not limited to this.

When the bits are occupied by the M pieces of present status information in the preset field according to the priority levels, the bits occupied by the M pieces of present status information in the preset field may be determined by the priority levels of the various devices. The higher the priority is, the higher position the bits occupied by the present status information in the preset field are, that is, several bits at the front of the preset field. For example, if the preset field includes 32 bits, a device with a higher priority may occupy the front several bits. Alternatively, the higher the priority of the device is, the more bits occupied by the present status information in the preset field are, thus, the greater a number of safety levels may be described. The M pieces of present status information may occupy a same number of bits in the preset field. In embodiments of the present disclosure, an example is described to determine the bits taken by the present status information in the preset field. However, embodiments of the present disclosure are not limited to this.

After the system status information of the LIDAR and the M pieces of present status information are determined, the system status information of the LIDAR and the M pieces of present status information may be output by the preset field. As such, a problem that an error code cannot feedback the whole system status well may be solved, and the monitoring of the whole status of the system may be improved, thus the efficiency of obtaining the system status of the LIDAR may be increased.

In the method of monitoring the system status of the LIDAR consistent with embodiments of the present disclosure, when the system status information of the LIDAR is output, the M pieces of present status information corresponding to the N devices of the LIDAR may be obtained first, and the system status information of the LIDAR may be determined according to the M pieces of present status information. Then, the system status information of the LIDAR and the M pieces of present status information may be output by the preset field. As such, the problem that an error code cannot feedback the whole system status well may be solved, and the monitoring of the whole status of the system may be improved, thus the efficiency of obtaining the system status of the LIDAR may be increased.

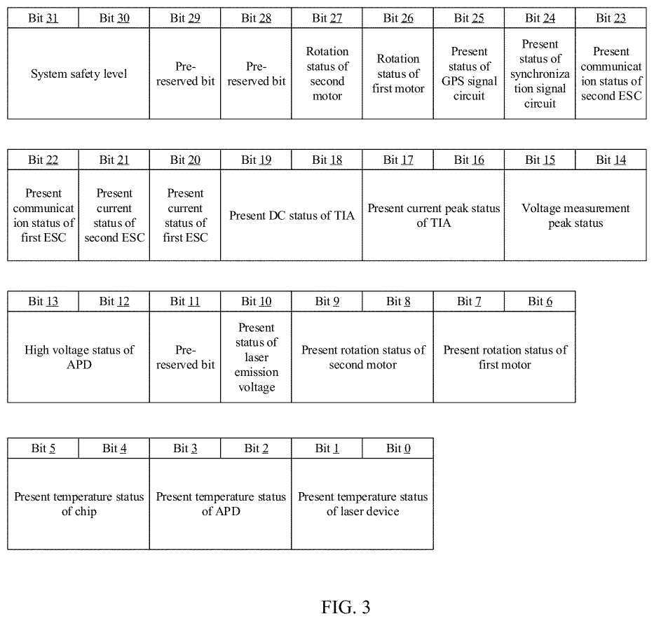

Based on embodiments of FIG. 2, to further describe how the system status information of the LIDAR is determined according to the M pieces of present status information in embodiments of the present disclosure, an example of using an unsigned number uint32_t to record the system status information of the LIDAR is described. The 31st bit (bit 30) and the 32nd bit (bit 31) may be used to represent a safety level (ERR_LEVEL) of the system. The 1st bit (bit 0) and the 2nd bit (bit 1) may be used to represent a present temperature status of the laser device. The 3rd bit (bit 2) and the 4th bit (bit 3) may be used to represent a present temperature status of the APD. The 5th bit (bit 4) and the 6th bit (bit 5) may be used to represent a present temperature status of the chip. The 7th bit (bit 6) and the 8th bit (bit 7) may be used to represent a present speed status of the first motor. The 9th bit (bit 8) and the 10th bit (bit 9) may be used to represent a present speed status of the second motor. The 11th bit (bit 10) may be used to represent a present status of a laser emission voltage. The 12th bit (bit 11) may be a reserved bit. The 13th bit (bit 12) and the 14th bit (bit 13) may be used to represent a present high voltage status of the APD. The 15th bit (bit 14) and the 16th bit (bit 15) may be used to represent a voltage measurement peak status. The 17th bit (bit 16) and the 18th bit (bit 17) may be used to represent a present peak status of a trans-impedance amplifier (TIA). The 19th bit (bit 18) and the 20th bit (bit 19) may be used to represent a present direct current (DC) status of the TIA. The 21st bit (bit 20) may be used to represent a present current status of a first electronic speed control (ESC), and the 22nd bit (bit 21) may be used to represent a present current status of a second electronic speed control (ESC). The 23rd bit (bit 22) may be used to represent a present communication status of the first ESC, and the 24nd bit (bit 23) may be used to represent a present communication status of a second ESC. The 25th bit (bit 24) may be used to represent a present status of a synchronization signal device. The 26th bit (bit 25) may be used to represent a present status of a global positioning system (GPS) signal device. The 27th bit (bit 26) may be used to represent a rotation status of the first motor, and the 28th bit (bit 27) may be used to represent a rotation status of the second motor. The 29th bit (bit 28) and the 30th bit (bit 29) may be reserved bits. FIG. 3 is a schematic diagram showing the preset field according to some embodiments of the present disclosure. In embodiments of the present disclosure, the preset field shown in FIG. 3 is described as an example. However, embodiments of the present disclosure are not limited to this. Some embodiments are used to describe how the system status information of the LIDAR is determined according to the M pieces of present status information.

In some embodiments, when the N devices include the laser device, the APD, and the chip, the system status information of the LIDAR may be determined according to the M pieces of present status information. The system status information of the LIDAR may be determined according to the present temperature of the laser device, the present temperature of the APD, the present temperature of the chip, and a first predetermined rule.

The first predetermined rule may include that, if safety levels corresponding to at least two pieces of status information of the present temperature of the laser device, the present temperature of the APD, or the present temperature of the chip are Warning, the safety level corresponding to the system status information of the LIDAR may be Error.

For example, when the system status information of the LIDAR is determined according to the present temperature of the laser device, the present temperature of the APD, the present temperature of the chip, and a first predetermined rule, the present temperature of the laser device may take the 1st bit (bit 0) and the 2nd bit (bit 1) of the preset field. When the temperature of the laser belongs to [−45, 85] (unit: ° C.), the safety level corresponding to the present temperature of the laser device may be determined to be Normal, and bit 0 and bit 1 may be set to 00. When the present temperature of the laser device is too low, and the present temperature of the laser device belongs to [−50, −45) (unit: ° C.), the safety level corresponding to the present temperature of the laser device may be determined to be Warning. When the present temperature of the laser device belongs to (−∞, −50) (unit: ° C.), the safety level corresponding to the present temperature of the laser device may be determined to be Error, and bit 0 and bit 1 may be set to 10.

In some embodiments, when a safety level corresponding to present status information corresponding to a certain device is Warning, a small error may exist in the device, which may affect normal use of the device. However, the device may continue to be used. When the safety level corresponding to the present status information of a certain device is Error, troubleshooting may be needed, and continued use may not be recommended.

The present temperature of the APD may occupy the 3rd bit (bit 2) and the 4th bit (bit 3) of the preset field. When the present temperature of the APD belongs to [−40, 100] (unit: ° C.), the safety level corresponding to the present temperature of the APD may be determined to be Normal, and bit 2 and bit 3 may be set to 00. When the present temperature of the APD is too low and belongs to [−45, −40) (unit: ° C.), the safety level corresponding to the present temperature of the APD may be determined to be Warning. When the present temperature of the APD belongs to (−∞, −50) (unit: ° C.), the safety level corresponding to the present temperature of the APD may be determined to be Error, bit 2 and bit 3 may be set to 10. When the present temperature of the APD is too high and belongs to (100, 105) (unit: ° C.), the safety level corresponding to the present temperature of the APD may be determined to be Warning. When the present temperature of the APD belongs to [105, +∞) (unit: ° C.), the safety level corresponding to the present temperature of the APD may be determined to be Error, and bit 2 and bit 3 may be set to 01.

The present temperature of the chip may occupy the 5th bit (bit 4) and the 6th bit (bit 5) of the preset field. When the present temperature of the chip belongs to [−40, 100] (unit: ° C.), the safety level corresponding to the present temperature of the chip may be determined to be Normal, and bit 4 and bit 5 may be set to 00. When the present temperature of the chip is too low and belongs to [−45, −40) (unit: ° C.), the safety level corresponding to the present temperature of the chip may be determined to be Warning. When the present temperature of the chip belongs to (−∞, −45) (unit: ° C.), the safety level corresponding to the present temperature of the chip may be determined to be Error, bit 4 and bit 5 may be set to 10. When the present temperature of the chip is too high and belongs to (100, 105) (unit: ° C.), the safety level corresponding to the present temperature of the chip may be determined to be Warning. When the present temperature of the chip belongs to [105, +∞) (unit: ° C.), the safety level corresponding to the present temperature of the chip may be determined to be Error, and bit 4 and bit 5 may be set to 01.

After the safety level corresponding to each status information of the present temperature of the laser device, the present temperature of the APD, and the present temperature of the chip is determined, if the safety levels corresponding to at least two pieces of status information of the present temperature of the laser device, the present temperature of the APD, and the present temperature of the chip are Warning, the safety level corresponding to the system status information of the LIDAR may be determined to be Error. Thus, the present system may need to perform troubleshooting and continued use may not be recommended. Therefore, the system status information of the LIDAR may be determined, the problem that the error code cannot feedback the whole system status well may be solved, and monitoring the system whole status may be improved. As such, the efficiency of obtaining the system status information of the LIDAR may be improved.

In some embodiments, when the N devices include the first motor and the second motor, the system status information of the LIDAR may be determined according to the present rotation speed of the first motor, the present rotation speed of the second motor, and the second predetermined rule.

The second predetermined rule may include that, if both the safety levels corresponding to the present rotation speed of the first motor and the present rotation speed of the second motor are Warning, the safety level corresponding to the system status information of the LIDAR may be determined to be Error.

For example, when the system status information of the LIDAR is determined according to the present rotation speed of the first motor, the present rotation speed of the second motor, and the second predetermined rule, the present rotation speed status of the first motor may occupy the 7th bit (bit 6) and the 8th bit (bit 7) of the preset field. When a present rotation speed error of the first motor belongs to [0, 5‰], the safety level corresponding to the present rotation speed of the first motor may be determined to be Normal, and bit 6 and bit 7 may be set to 00. When the present rotation speed of the first motor is too low, and the present rotation speed error of the first motor belongs to [−6‰, −5‰], the safety level corresponding to the present rotation speed of the first motor may be determined to be Warning. When the present rotation speed error of the first motor belongs to [−∞, −7‰], the safety level corresponding to the present rotation speed of the first motor may be determined to be Error, and bit 6 and bit 7 may be set to 10. When the present rotation speed of the first motor is too high, and the present rotation speed error of the first motor belongs to (5‰, 6‰], the safety level corresponding to the present rotation speed of the first motor may be determined to be Warning. When the present rotation speed error of the first motor belongs to [7‰, +∞), the safety level corresponding to the present rotation speed of the first motor may be determined to be Error, and bit 6 and bit 7 may be set to 01.

The present speed status of the second motor may occupy the 9th bit (bit 8) and the 10th bit (bit 9) of the preset field. When the present rotation speed error of the second motor belongs to [0, 5‰], the safety level corresponding to the present rotation speed of the second motor may be determined to be Normal, and bit 8 and bit 9 may be set to 00. When the present rotation speed of the second motor is too low, and the present rotation speed error of the second motor belongs to [−6‰, −5‰], the safety level corresponding to the present rotation speed of the second motor may be determined to be Warning. When the present rotation speed error of the second motor belongs to [−∞, −7‰], the safety level corresponding to the present rotation speed of the second motor may be determined to be Error, and bit 8 and bit 9 may be set to 10. When the present rotation speed of the second motor is too high, and the present rotation speed error of the second motor belongs to (5‰, 6‰], the safety level corresponding to the present rotation speed of the second motor may be determined to be Warning. When the present rotation speed error of the second motor belongs to [7‰, +∞), the safety level corresponding to the present rotation speed of the second motor may be determined to be Error, and bit 8 and bit 9 may be set to 01.

After the safety levels corresponding to the present rotation speed of the first motor and the present rotation speed of the second motor are determined, respectively, if both the safety levels corresponding to the present rotation speed of the first motor and the present rotation speed of the second motor are Warning, the safety level corresponding to the system status information of the LIDAR may be determined to be Error. Thus, the present system may need to perform troubleshooting and continued use may not be recommended. Therefore, the system status information of the LIDAR may be determined, the problem that the error code cannot feedback the whole system status well may be solved, and monitoring the system whole status may be improved. As such, the efficiency of obtaining the system status information of the LIDAR may be improved.

In above embodiments, how to determine the system status information of the LIDAR according to the present statuses corresponding to the N devices is described, when the N devices include the laser device, the APD, and the chip. In above embodiments, how to determine the system status information of the LIDAR according to the present statuses corresponding to the N devices is also described, when the N devices include the first motor and the second motor. In some other embodiments, how to determine the system status information of the LIDAR according to the present statuses corresponding to the N devices is further described, when the N devices include the laser device, the APD, the chip, the first motor, and the second motor.

In some embodiments, when the N devices include the laser device, the APD, the chip, the first motor, and the second motor, the corresponding M pieces of present status information may include at least one of the present status of the laser device, the rotation status of the first motor, the rotation status of the second motor, or the present high voltage status of the APD.

For example, the present status of the laser emission voltage may occupy the 11th bit (bit 10) of the preset field. When a laser emission voltage error belongs to [−10%, 10%], the safety level corresponding to the laser emission voltage may be determined to be Normal, and bit 10 may be set to 0. When the laser emission voltage error belongs to (−∞, −10%) or (10%, +∞), the safety level corresponding to the laser emission voltage may be determined to be Error, and bit 10 may be set to 1.

The present high voltage status of the APD may occupy the 13th bit (bit 12) and the 14th bit (bit 13) of the preset field. When a high voltage error of the APD belongs to [−7%, 7%], the safety level corresponding to the present high voltage status of the APD may be determined to be Normal, and bit 12 and bit 13 may be set to 00. When the present high voltage of the APD is too low, and the high voltage error of the APD belongs to (−∞, −7%), the safety level corresponding to the present high voltage status of the APD may be determined to be Error, and bit 12 and bit 13 may be set to 10. When the present high voltage of the APD is too high, and the high voltage error of the APD belongs to (7%, +∞), the safety level corresponding to the present high voltage status of the APD may be determined to be Error, and bit 12 and bit 13 may be set to 01.

The rotation status of the first motor may occupy the 27th bit (bit 26) of the preset field. When the first motor rotates normally, the safety level corresponding to the rotation status of the first motor may be determined to be Normal, and bit 26 may be set to 0. When the rotation status of the first motor is Stall, the safety level corresponding to the rotation status of the first motor may be determined to be Error, and bit 26 may be set to 1.

The rotation status of the second motor may occupy the 28th bit (bit 27) of the preset field. When the second motor rotates normally, the safety level corresponding to the rotation status of the second motor may be determined to be Normal, and bit 27 may be set to 0. When the rotation status of the second motor is Stall, the safety level corresponding to the rotation status of the second motor may be determined to be Error, and bit 27 may be set to 1.

In some embodiments, the system status information of the LIDAR may be determined according to the M pieces of present status information and a third predetermined rule.

The third predetermined rule may include that, if the safety level corresponding to any one of the M pieces of present status information is Warning and no safety level corresponding to any of the M pieces of present status information is Error, the safety level corresponding to the system status information of the LIDAR may be determined to be Warning.

When the N devices include the laser device, the APD, the chip, the first motor, and the second motor, after the M pieces of present status information corresponding to the N devices are obtained, the safety level corresponding to the system status information of the LIDAR may be determined according to the third predetermined rule. In some embodiments, when the safety level corresponding to any one of the M pieces of present status information is Warning and non-Error, the safety level corresponding to the system status information of the LIDAR may be determined to be Warning, which means that small error may exist in the system and may impact the normal use of the system, but the system may continue to be used. Thus, the problem that the error code cannot feedback the whole system status well may be solved, and monitoring the system whole status may be improved. As such, the efficiency of obtaining the system status of the LIDAR may be increased.

In some embodiments, the system status information of the LIDAR may be determined according to the M pieces of present status information and the fourth predetermined rule.

The fourth predetermined rule may include that, if the safety level corresponding to any one of the M pieces of present status information is Error, the safety level corresponding to the system status information of the LIDAR may be determined to be Error.

When the N devices include the laser device, the APD, the chip, the first motor, and the second motor, after the M pieces of present status information corresponding to the N devices are obtained, the safety level corresponding to the system status information of the LIDAR may be determined according to the fourth predetermined rule. In some embodiments, when the safety level corresponding to any one of the M pieces of present status information is Error, the safety level corresponding to the system status information of the LIDAR may be determined to be Error, which means that the present system may need to perform troubleshooting and continued use may not be recommended to continue for use. The problem that the error code cannot feedback the whole system status well may be solved, and the monitoring of the whole status of the system may be improved. As such, the efficiency of obtaining the system status of the LIDAR may be increased.

In some embodiments, the system status information of the LIDAR may be determined according to the M pieces of present status information and the fifth predetermined rule.

The fifth predetermined rule may include that, if the safety levels corresponding to at least two of the M pieces of present status information are Error, the safety level corresponding to the system status information of the LIDAR may be determined to be severe Error. When the safety level corresponding to the system status information of the LIDAR is severe Error, the present system may have a severe error and may be prohibited for use.

In some embodiments, when the N devices include the laser device, the APD, the chip, the first motor, and the second motor, after the M pieces of present status information corresponding to the N devices are obtained, the safety level corresponding to the system status information of the LIDAR may be determined according to the fifth predetermined rule. In some embodiments, when the safety levels corresponding to at least two of the M pieces of present status information are Error, the safety level corresponding to the system status information of the LIDAR may be determined to be severe Error, which means that the present system may have a severe error and may be prohibited for use. The problem that the error code cannot feedback the whole system status well may be solved, and the monitoring of the whole status of the system may be improved. As such, the efficiency of obtaining the system status of the LIDAR may be increased.

In some embodiments, when the safety level corresponding to the system status information of the LIDAR is determined according to the M pieces of present status information and the third predetermined rule, the M pieces of present status information and the fourth predetermined rule, and the M pieces of present status information and the fifth predetermined rule, the N devices of the LIDAR may further include at least one of a TIA, a first ESC, a second ESC, a synchronization signal device, or a GPS signal device. The corresponding M pieces of present status information may include at least one of a present current peak status of the TIA, a present current status of the TIA, a present current status of the first ESC, a present current status of the second ESC, a present communication status of the first ESC, a present communication status of the second ESC, a present status of the synchronization signal device, a present status of the GPS signal device, or a voltage measurement peak status. For example, when the M pieces of present status information include the voltage measurement peak status, the voltage measurement peak status may occupy the 15th bit (bit 14) and the 16th bit (bit 15) of the preset field. When a voltage measurement peak is normal, bit 14 and bit 15 may be set to 00. When the voltage measurement peak is too low, the safety level corresponding to the voltage measurement peak may be determined to be Error, and bit 14 and bit 15 may be set to 10. When the voltage measurement peak is too large, the safety level corresponding to the voltage measurement peak may be determined to be Error, and bit 14 and bit 15 may be set to 01.

When the M pieces of present status information further include the present current peak status of the TIA and the present DC status of the TIA, the present current peak status of the TIA may occupy the 17th bit (bit 16) and 18th bit (bit 17) of the preset field. When a present current peak of the TIA is normal, bit 16 and bit 17 may be set to 00. When the present current peak of the TIA is too low, the safety level corresponding to the present current peak of the TIA may be determined to be Error, and bit 16 and bit 17 may be set to 10. When the present current peak of the TIA is too large, the safety level corresponding to the present current peak of the TIA may be determined to be Error, and bit 16 and bit 17 may be set to 01. The present DC status of the TIA may occupy the 19th bit (bit 18) and 20th bit (bit 19) of the preset field. When a present DC of the TIA is normal, bit 18 and bit 19 may be set to 00. When the present DC of the TIA is too low, the safety level corresponding to the present DC of the TIA may be determined to be Error, and bit 18 and bit 19 may be set to 10. When the present DC of the TIA is too large, the safety level corresponding to the present DC of the TIA may be determined to be Error, and bit 18 and bit 19 may be set to 01.

When the M pieces of present status information include the present current status of the first ESC and the present current status of the second ESC, the present current status of the first ESC may occupy the 21st bit (bit 20) of the preset field, and the present current status of the second ESC may occupy the 22nd bit (bit 21) of the preset field. When the present current of the first ESC is smaller than or equal to 0.5 A, the safety level corresponding to the present current of the first ESC may be determined to be normal, and bit 20 may be set to 0. When the present current of the first ESC is larger than 0.5 A, the safety level corresponding to the present current of the first ESC may be determined to be Error, and bit 20 may be set to 1. When the present current of the second ESC is smaller than or equal to 0.5 A, the safety level corresponding to the present current of the second ESC may be determined to be normal, and bit 21 may be set to 0. When the present current of the second ESC is larger than 0.5 A, the safety level corresponding to the present current of the second ESC may be determined to be Error, and bit 21 may be set to 1.

When the M pieces of present status information include the present communication status of the first ESC and the present communication status of the second ESC. The present communication status of the first ESC may occupy the 23rd bit (bit 22) of the preset field, and the present communication status of the second ESC may occupy the 24th bit (bit 23) of the preset field. When the present communication status of the first ESC is normal, bit 22 may be set to 0. When the present communication status of the first ESC is abnormal, the safety level corresponding to the present communication status of the first ESC may be determined to be Error, and bit 22 may be set to 1. When the present communication status of the second ESC is normal, bit 23 may be set to 0. When the present communication status of the second ESC is abnormal, the safety level corresponding to the present communication status of the second ESC may be determined to be Error, and bit 23 may be set to 1.

When the M pieces of present status information include the present status of the synchronization signal device, the present status of the synchronization signal device may occupy the 25th bit (bit 24) of the preset field. When the present status of the synchronization signal device is no synchronization signal, the safety level corresponding to the present status of the synchronization signal device may be determined to be Warning, and bit 24 may be set to 0. When the present status of the synchronization signal device is having the synchronization signal, the safety level corresponding to the present status of the synchronization signal device may be determined to be Error, and bit 24 may be set to 1.

When the M pieces of present status information include the present status of the GPS signal device, the present status of the GPS signal device may occupy the 26th bit (bit 25) of the preset field. When the present status of the GPS signal device is no GPS signal, the safety level corresponding to the present status of the GPS signal device may be determined to be Warning, and bit 25 may be set to 0. When the present status of the GPS signal device is having GPS signal, the safety level corresponding to the present status of the GPS signal device may be determined to be Error, and bit 25 may be set to 1.

When the N devices of the LIDAR further include at least one of the TIA, the first ESC, the second ESC, the synchronization signal device, or the GPS signal device, the safety level corresponding to the system status information of the LIDAR, which is determined according to the M pieces of present status information corresponding to the N devices, may still be determined according to the third predetermined rule, the fourth predetermined rule, and the fifth predetermined rule. The problem that the error code cannot well provide feedback about the whole system status may be solved, and the monitoring of the whole status of the system may be improved. As such, the efficiency of obtaining the system status of the LIDAR may be increased.

After the safety level corresponding to the system status information of the LIDAR according to the first predetermined rule, the second predetermined rule, the third predetermined rule, the fourth predetermined rule, and the fifth predetermined rule, the system status information of the LIDAR may occupy the 31st bit (bit 30) and the 32nd bit (bit 31) of the preset field. When bit 30 and bit 31 are 00, the safety level corresponding to the system status information of the LIDAR may be Normal, and the system may be used normally. When bit 30 and bit 31 are 10, the safety level corresponding to the system status information of the LIDAR may be Warning, the small error may exist in the present system, which may impact the normal use of the system, but the system can still continue to be used. When bit 30 and bit 31 are 01, the safety level corresponding to the system status information of the LIDAR may be Error, troubleshooting may be needed, and continued use may not be recommended. When bit 30 and bit 31 are 11, the safety level corresponding to the system status information of the LIDAR may be severe Error, the present system may have a severe error and may be prohibited for use. Thus, the problem that the error code cannot well provide feedback about the whole system status may be solved, and the monitoring of the whole status of the system may be improved. As such, the efficiency of obtaining the system status of the LIDAR may be increased.

In embodiments of the present disclosure, the system status of the LIDAR is described by four safety levels, for example, Normal, Warning, Error, and severe Error. The system status of the LIDAR may further include more levels to describe the status information in more detail. For example, when three bits of the preset field are used to represent the system status of the LIDAR, eight corresponding safety levels may be described. The safety level may not be limited to the bit format in embodiments, which may be set according to actual needs. For example, the safety levels may be represented by a number or other formats. When the safety level is represented by the number, the larger the number is, the more severe the error of the system status of the LIDAR is.

When the system status information of the LIDAR and the M pieces of present status information are output through the preset field, FIG. 3 is described as an example in embodiments of the present disclosure. The bits occupied by the M present statuses in the preset field may be randomly set, which are not further limited by embodiments of the present disclosure.

The preset field of embodiments of the present disclosure further includes reserved bits. The reserved bits include the 12th bit (bit 11), the 29th bit (bit 28, and the 30th bit (bit 29). The reserved bits may be used to subsequently expand the devices of the LIDAR to identifying a present status of a new device added after the expansion through the preserved bits.

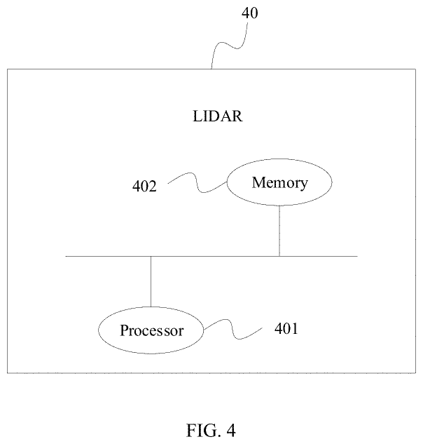

FIG. 4 is a schematic structural diagram of a LIDAR 40 according to some embodiments of the present disclosure. As shown in FIG. 4, the LIDAR 40 includes a processor 401 and a memory 402.

The memory 402 may be configured to store a program instruction.

The processor 401 may be configured to obtain the M pieces of present status information corresponding to the N devices of the LIDAR 40. Each of the N devices may correspond to at least one piece of the status information. N may be an integer greater than 2, and M may be an integer greater than or equal to N.

The processor 401 may be further configured to determine the system status of the LIDAR 40 according to the M pieces of present status information.

The processor 401 may be further configured to output the system status information of the LIDAR 40 and the M pieces of present status information by the preset field.

In some embodiments, the N devices may include the laser device, the APD, and the chip. The correspondingly M pieces of present status information may include the present temperature of the laser device, the present temperature of the APD, and the present temperature of the chip. In some other embodiments, the N devices may include the first motor and the second motor. The correspondingly M pieces of present status information may include the present rotation speed of the first motor and the present rotation speed of the second motor.

In some embodiments, when the N devices include the laser device, the APD, and the chip, the processor 401 may be configured to determine the system status information of the LIDAR 40 according to the present temperature of the laser device, the present temperature of the APD, the present temperature of the chip, and the first predetermined rule.

The first predetermined rule may include that, if the safety levels corresponding to at least two pieces of status information of the present temperature of the laser device, the present temperature of the APD, and the present temperature of the chip, determining the safety level corresponding to the system status information of the LIDAR 40 to be Error.

In some embodiments, when the N devices include the first motor and the second motor, the processor 401 may be configured to determine the system status information of the LIDAR 40 according to the present rotation speed of the first motor, the present rotation speed of the second motor, and the second predetermined rule.

The second predetermined rule may include that, if both the safety levels corresponding to the present rotation speed of the first motor and the present rotation speed of the second motor are Warning, determining the safety level corresponding to the system status information of the LIDAR 40 to be Error.

In some embodiments, when the N devices include the laser device, the APD, the chip, the first motor, and the second motor, the M pieces of present status information may further include at least one of the present status of the laser emission voltage, the rotation status of the first motor, the rotation status of the second motor, or the present high voltage of the APD.

In some embodiments, the processor 401 may be further configured to determine the system status information of the LIDAR 40 according to the M pieces of present status information and the third predetermined rule.

The third predetermined rule may include, when the safety level corresponding to any one of the M pieces of present status information is Warning and no safety level of any one of the M pieces of present status information is Error, determining the safety level corresponding to the system status information of the LIDAR 40 to be Warning.

In some embodiments, the processor 401 may be further configured to determine the system status information of the LIDAR 40 according to the M pieces of present status information and the fourth predetermined rule.

The fourth predetermined rule may include, when the safety level corresponding to any one of the M pieces of present status information is Error, determining the safety level corresponding to the system status information of the LIDAR 40 to be Error.

In some embodiments, the processor 401 may be further configured to determine the system status information of the LIDAR 40 according to the M pieces of present status information and the fifth predetermined rule.

The fifth predetermined rule may include, when the safety levels corresponding to at least two of the M pieces of present status information are Error, determining the safety level corresponding to the system status information of the LIDAR 40 to be severe Error.

In some embodiments, the preset field may further include reserved bits.

In some embodiments, the M pieces of present status information may occupy different bits of the preset field.

In some embodiments, the bits of the preset field occupied by the M pieces of present status information may be determined according to the priority level of the devices.

The LIDAR 40 may correspondingly execute the technical solution of the method of monitoring the system status of the LIDAR 40 shown in any one of embodiments. The implementation principle and technical effects are similar, which are not repeated here.

Embodiments of the present disclosure may further provide a computer-readable storage medium. The computer-readable storage medium may store a computer program. When the computer program is executed by the processor, the method of monitoring the system status of the LIDAR of any embodiment may be executed.

The computer-readable storage medium may correspondingly execute the technical solution of the method of monitoring the system status of the LIDAR of any one of embodiments. The implementation principle and technical effects are similar, which are not repeated here.

Above embodiments are only used to illustrate the technical solution of the present disclosure, but not to limit it. Although the present disclosure is described in detail with reference to above embodiments, those of ordinary skill in the art should understand that modifications may be still be performed on the technical solution described in embodiments, and equivalent replacements may still be performed on some or all technical features. These modifications and replacements do not cause the essence of the corresponding technical solution to depart from the scope of embodiments of the present disclosure.

What is claimed is:

1. A method of monitoring a system status of a LIDAR comprising:
obtaining M pieces of present status information corresponding to N devices of the LIDAR, each of the N devices corresponding to at least one of the M pieces of present status information, N being an integer greater than or equal to 2, and M being an integer greater than or equal to N;
determining system status information of the LIDAR according to the M pieces of present status information; and
outputting the system status information of the LIDAR and the M pieces of present status information through a preset field.

2. The method of claim 1, wherein:
the N devices include a laser device, an avalanche photo diode (APD), and a chip, and the M pieces of present status information include a present temperature of the laser device, a present temperature of the APD, and a present temperature of the chip; and/or
the N devices include a first motor and a second motor, and the M pieces of present status information include a present rotation speed of the first motor and a present rotation speed of the second motor.

3. The method of claim 2, wherein:
the N devices include the laser device, the APD, and the chip; and
determining the system status information of the LIDAR according to the M pieces of present status information includes determining the system status information of the LIDAR according to the present temperature of the laser device, the present temperature of the APD, the present temperature of the chip, and a predetermined rule, the predetermined rule including:
in response to safety levels corresponding to at least two pieces of status information among the present temperature of the laser device, the present temperature of the APD, and the present temperature of the chip being Warning, determining a safety level corresponding to the system status information of the LIDAR to be Error.

4. The method of claim 2, wherein:
the N devices include the first motor and the second motor; and
determining the system status information of the LIDAR according to the M pieces of present status information includes determining the system status information of the LIDAR according to the present rotation speed of the first motor, the present rotation speed of the second motor, and a predetermined rule, the predetermined rule including:
in response to both safety levels corresponding to the present rotation speed of the first motor and the present rotation speed of the second motor being Warning, determining a safety level corresponding to the system status information of the LIDAR to be Error.

5. The method of claim 2, wherein:
the N devices include the laser device, the APD, the chip, the first motor, and the second motor; and
the M pieces of present status information further include at least one of a present status of a laser emission voltage, a rotation status of the first motor, a rotation status of the second motor, or a present high voltage status of the APD.

6. The method of claim 5, wherein determining the system status information of the LIDAR according to the M pieces of present status information includes determining the system status information of the LIDAR according to the M pieces of present status information and a predetermined rule, the predetermined rule including:
in response to any one of safety levels corresponding to the M pieces of present status information being Warning and none of the safety levels corresponding to the M pieces of present status information being Error, determining a safety level corresponding to the system status information of the LIDAR to be Warning.

7. The method of claim 5, wherein determining the system status information of the LIDAR according to the M pieces of present status information includes determining the system status information of the LIDAR according to the M pieces of present status information and a predetermined rule, the predetermined rule including:
in response to a safety level corresponding to any one of the M pieces of present status information being Error, determining a safety level corresponding to the system status information of the LIDAR to be Error.

8. The method of claim 5, wherein determining the system status information of the LIDAR according to the M pieces of present status information includes determining the system status information of the LIDAR according to the M pieces of present status information and a predetermined rule, the predetermined rule including:
in response to safety levels corresponding to at least two of the M pieces of present status information being Error, determining a safety level corresponding to the system status information of the LIDAR to be severe Error.

9. The method of claim 1, wherein the M pieces of present status information occupy different bits of the preset field.

10. The method of claim 1, wherein bits of the preset field occupied by the M pieces of present status information are determined by priority levels of the N devices.

11. A LIDAR comprising:
a memory storing a program instruction; and
a processor configured to:
obtain M pieces of present status information corresponding to N devices of the LIDAR, each one of the N devices corresponding to at least one of the M pieces of present status information, N being an integer greater than or equal to two, and M being an integer greater than or equal to N;
determine system status information of the LIDAR according to the M pieces of present status information; and
output the system status information of the LIDAR and the M pieces of present status information through a preset field.

12. The LIDAR of claim 11, wherein:
the N devices include a laser device, an APD, and a chip, and the M pieces of present status information include a present temperature of the laser device, a present temperature of the APD, and a present temperature of the chip; and/or
the N devices include a first motor and a second motor, and the M pieces of present status information include a present rotation speed of the first motor and a present rotation speed of the second motor.

13. The LIDAR of claim 12, wherein:
the N devices include the laser device, the APD, and the chip; and
the processor is configured to determine the system status information of the LIDAR according to the present temperature of the laser device, the present temperature of the APD, the present temperature of the chip, and a predetermined rule, the predetermined rule including:
in response to safety levels corresponding to at least two pieces of status information among the present temperature of the laser device, the present temperature of the APD, and the present temperature of the chip being Warning, determining a safety level corresponding to the system status information of the LIDAR to be Error.

14. The LIDAR of claim 12, wherein:
the N devices include the first motor and the second motor; and
the processor is configured to determine the system status information of the LIDAR according to the present rotation speed of the first motor, the present rotation of the second motor, and a predetermined rule, the predetermined rule including:
in response to both safety levels corresponding to the present rotation speed of the first motor and the present rotation speed of the second motor are Warning, determining a safety level corresponding to the system status information of the LIDAR to be Error.

15. The LIDAR of claim 12, wherein:
the N devices include the laser device, the APD, the chip, the first motor, and the second motor; and
the M pieces of present status information further include at least one of a present status of a laser emission voltage, a rotation status of the first motor, a rotation status of the second motor, or a present high voltage status of the APD.

16. The LIDAR of claim 15, wherein the processor is further configured to:
determine the system status information of the LIDAR according to the M pieces of present status information and a predetermined rule, the predetermined rule including:
in response to any one of safety levels corresponding to the M pieces of present status information being Warning and none of the safety levels corresponding to the M pieces of present status information being Error, determining a safety level corresponding to the system status information of the LIDAR to be Warning.

17. The LIDAR of claim 15, wherein the processor is further configured to:
determine the system status information of the LIDAR according to the M pieces of present status information and a predetermined rule, the predetermined rule including:
in response to a safety level corresponding to any one of the M pieces of present status information being Error, determining a safety level corresponding to the system status information of the LIDAR to be Error.

18. The LIDAR of claim 15, wherein the processor is further configured to:
determine the system status information of the LIDAR according to the M pieces of present status information and a predetermined rule, the predetermined rule including:
in response to safety levels corresponding to at least two of the M pieces of present status information being Error, determining a safety level corresponding to the system status information of the LIDAR to be severe Error.

19. The LIDAR of claim 11, wherein the M pieces of present status information occupy different bits of the preset field.

20. The LIDAR of claim 11, wherein bits of the preset field occupied by the M pieces of present status information are determined by priority levels of the N devices.
